(19) United States
(12) Patent Application Publication
(10) Pub. No.: US 2005/0207831 A1
(43) Pub. Date: Sep. 22, 2005

(54) Coated piston pin

(76) Inventors: Donald R. Van Der Moere, Spencer, IN (US); Brent A. Newkirk, New Palestine, IN (US); Bradley J. Oblak, Lombard, IL (US); John L. Cagney, Downers Grove, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 10/802,984

(22) Filed: Mar. 17, 2004

(51) Int. Cl. F16J 1/16

(52) U.S. Cl. 403/150

(57) ABSTRACT

A piston pin including a tubular body having a cylindrical exterior margin, the exterior margin being shiftably matable with an inside margin of a pin bore of a connecting rod, the margin of the pin bore having a surface formed of the material forming the connecting rod, the mating being in a surface to surface engagement. A method of forming a piston pin and a piston pin, connecting rod combination are further included.

### TECHNICAL FIELD

The present invention relates to internal combustion engines. More particularly, the present invention relates to a coated piston pin for shiftably connecting a connecting rod to a piston.

### BACKGROUND OF THE INVENTION

The moving parts of an internal combustion engine serve an important function in turning heat energy into mechanical energy. In a conventional internal combustion engine that has reciprocating pistons, the moving parts of the engine further convert reciprocal motion into rotary motion. Some of the principal moving parts of an internal combustion engine are the piston assembly, connecting rods, and a crankshaft assembly. The burning of the fuel-air mixture within the cylinder exerts a pressure thus causing it to reciprocate within the cylinder. The reciprocation of the piston is transmitted by the connecting rod to the crankshaft. The action of the connecting rod and crankshaft converts the reciprocation of the piston to a rotary motion.

A prior art piston, piston pin, and connecting rod are depicted in prior art FIG. 1. As noted in FIG. 2, a typical piston has a head and a skirt. The head has a plurality of lands for supporting respective piston rings. A piston pin boss is defined in the skirt of the piston. A groove may be provided in the skirt for locking a piston pin snap ring for securing the piston pin in the piston. Alternatively, a threaded hole that intersects the piston pin boss may be provided for a piston pin lock screw.

The piston is attached to the connecting rod by a piston pin (wrist pin) see FIGS. 3a, 3b, prior art. The pin passes through the piston pin bosses of this piston and through the upper end of the connecting rod. The upper end of the connecting rod rides within the piston in the middle of the piston pin. Piston pins are typically made of alloy steel with a precision finish and are case hardened and sometimes chromium plated to increase their wearing qualities.

Referring again to FIG. 1, connecting rods must be light and yet strong enough to transmit the thrust of the piston to the crankshaft. Connecting rods are typically drop forged from a steel alloy capable of withstanding heavy loads without bending or twisting. Bores at the upper (small end) and lower (big end) ends of the connecting rods are machined to permit accurate fitting of bearings. The upper end of the connecting rod is connected to the piston by the piston pin. In the prior art, the upper bore (pin bore) of the connecting rod has a solid bearing (bushing) of bronze or similar material disposed therein that is in contact with the piston pin. As the lower end of the connecting rod revolves with the crankshaft, the upper end shifts back and forth on the piston pin. Although this movement is slight, in the past a bushing has been found necessary because of the high pressure and temperatures experienced.

There is a need in the industry to minimize the number of components comprising the moving parts of an internal combustion engine, as well as to minimize the number of steps necessary in their production. It would be a significant advantage if the solid bearing in the upper bore of the connecting rod could be eliminated. In the past, the bushing typically must be purchased from an outside source and then pressed into the pin bore of the connecting rod. Additionally, the inside diameter of the bushing must then be machined to achieve the final surface necessary. It would be a decided advantage to eliminate the need for the bushing and further to eliminate the step of machining the inside diameter of the bushing.

### SUMMARY OF THE INVENTION

The present invention substantially meets the aforementioned needs of the industry. By providing a suitable coating on the piston pin, the need for a solid bushing in the connecting rod pin bore is eliminated. This allows the piston pin to come into direct surface-to-surface contact with the connection rod and the piston. Preferably, the coating is chromium-nitride (Cr-Nitride or Cr—N). The Cr-Nitride coating is preferably applied by physical vapor deposition (PVD). Preferably a centerless buffing operation may be performed on the coated piston pin prior to installation. Preferably, the coating thickness is between 1 and 10 microns. There are no known limitations of the type of piston that the coated piston pin may be used with. Accordingly, the coated piston pin may be used with aluminum pistons of varying strength as well as steel pistons.

The present invention is a piston pin including a tubular body having a cylindrical exterior margin, the exterior margin being shiftably matable with an inside margin of a pin bore of a connecting rod, the margin of the pin bore having a surface formed of the material forming the connecting rod, the mating being in a surface to surface engagement. The present invention is further a method of forming a piston pin and a piston pin, connecting rod combination.

### A BRIEF DESCRIPTION OF THE DRAWINGS

FIG. 1 is a prior art exploded depiction of a piston assembly, piston pin, and a connecting rod;

FIG. 2 is a prior art cut-away depiction of a piston;

FIG. 3 is a prior art depiction of a piston pin partially disposed in a piston;

FIG. 3b is a prior art depiction of a piston pin partially disposed in a piston;

FIG. 4 is a perspective view of a piston pin made according to the present invention;

FIG. 5 is a perspective view of a connecting rod made according to the present invention;

FIG. 6 is a cut-away depiction of a deposition chamber for depositing the coating of the present invention; and

FIG. 7 is a perspective view of a centerless buffing operation.

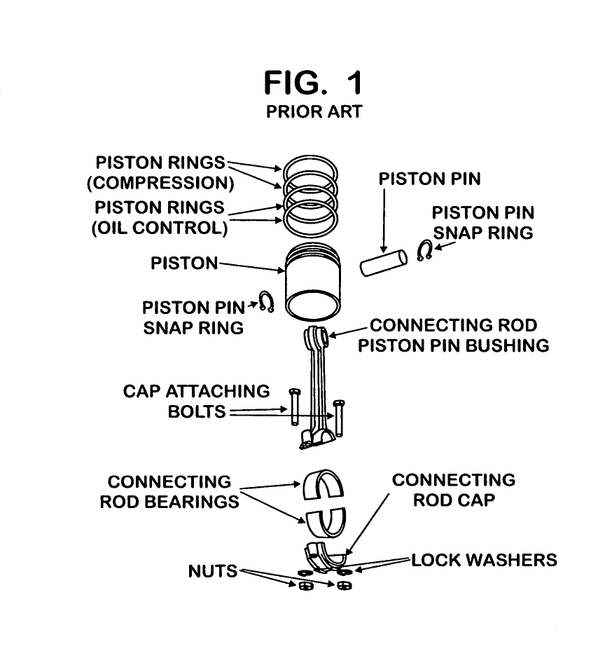

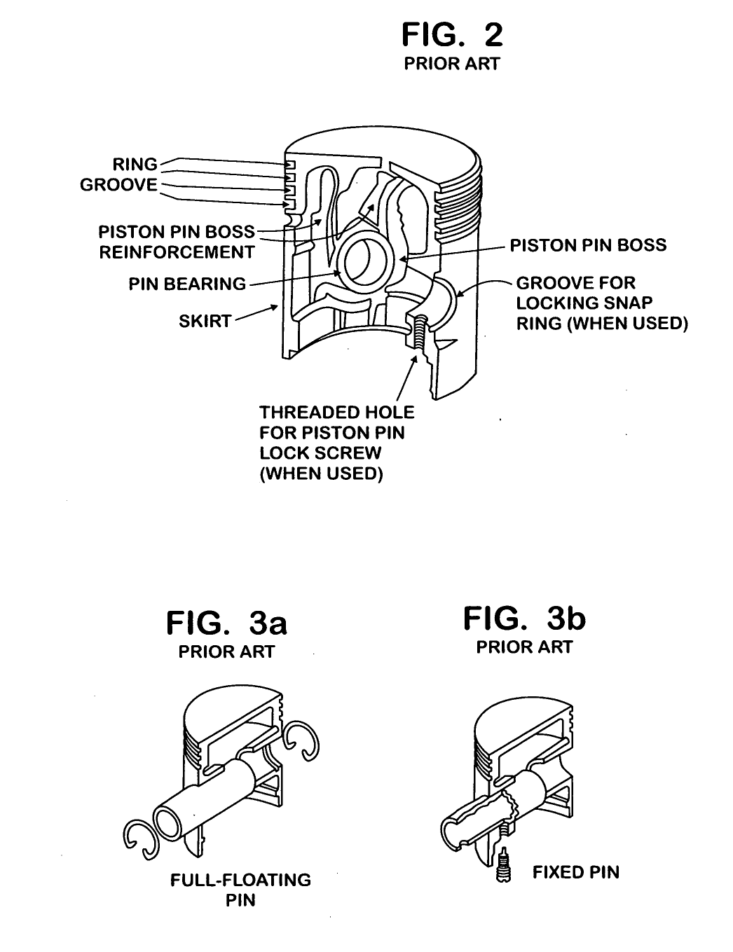

### DETAILED DESCRIPTION OF THE DRAWINGS

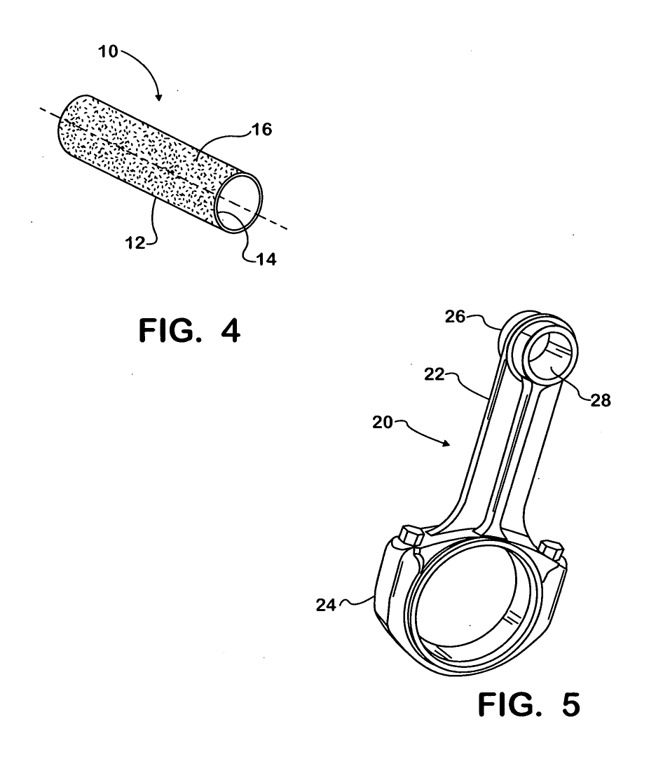

The piston pin and connecting rod of the present invention are shown generally at 10 and 20, respectively, in FIGS. 4 and 5.

The piston pin 10 has a generally tubular body 12. A lightening bore 14 is defined in the body 12 concentric with the longitudinal of the piston pin 10.

A coating 16 is applied to the external margin to the tubular body 12. The coating 16 is described in greater detail below. The coating 16 when applied becomes the external margin of the piston pin 10.

The connecting rod 20, depicted in FIG. 5, includes an elongated rod arm 22. A large end 24 is disposed at a first end of the rod arm 22. The large end 24 is designed to be rotatably engaged to a journal on the crankshaft of the engine.

A small end 26 is disposed at a second end of the rod arm 22. The small end 26 has a pin bore 28 defined therethrough. The pin bore 28 is formed concentric with the longitudinal of the small end 26. Notably, the interior margin of pin bore 28 does not include a bushing and is formed of the same material as that forming the remainder of the structure of the connecting rod 20. Accordingly, the inside diameter of the pin bore 28 is in direct surface to surface contact with the coating 16 of the piston pin 10 when the piston pin 10 is inserted into the pin bore 28 of the connecting rod 20 without the interposition of a bearing.

The coating 16 is preferably chromium nitride (Cr—N). The chromium nitride coating is a wear resistant coating preferably formed on the outside margin of the tubular body 12 of the piston pin 10 by physical vapor deposition process. The chromium nitride coating has high hardness, excellent oxidation resistance, and a low coefficient of friction. The coating 16 is typically metallic silver in color and is similar in appearance to polished stainless steel. The chromium nitride coating 16 has excellent adhesion to the piston pin 10. The coating 16 is typically applied in a relatively low temperature deposition process. This permits coating piston pin 10 without causing distortion, allowing the coating of the close tolerance, precision piston pin 10.

As noted above, the coating 16 is preferably applied by physical vapor deposition (PVD) processes. PVD covers a broad class of vacuum coating processes in which material is physically removed from a source by evaporation or sputtering, transported through a vacuum or partial vacuum by the energy of the vapor particles, and condensed as a film on the surface of a substrate (piston pin 10 in this case). Chemical compounds are deposited by either using a similar source material, or by introducing a gas (nitrogen, oxygen or simple hydrogens) containing the desired reactants, which react with metal(s) from the PVD source.

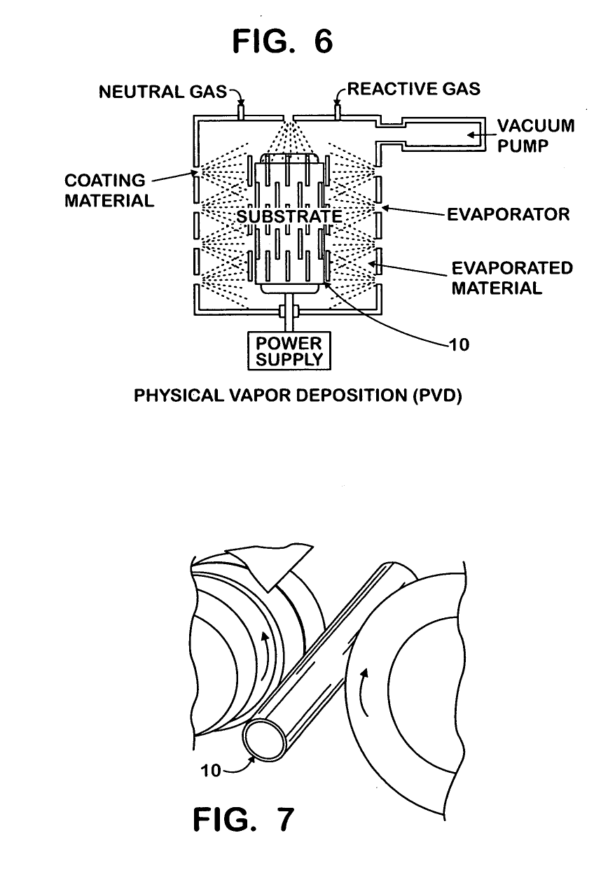

A schematic of a typical chamber for imparting a chromium nitride coating of a substrate by a PVD process is depicted in FIG. 6. The process of deposition consists of a number of phases:

chamber evacuation;

heating and cleaning of the substrate;

conditioning of the substrate;

coating the substrate; and

cooling and removal of the coated substrate.

The chamber is evacuated in order to remove all possible contaminants and to achieve the correct operating pressure for the process. The substrate is heated using either radiant heaters or “ion bombardment” which serves to remove adsorbed contamination from the surface. Cleaning takes place through a combination of ion bombardment (sputtering) and activated chemical cleaning using hydrogen. The hot piston pin 10 (typically between 200C and 450C) is “conditioned” by running the evaporation sources for a short time while a high voltage (around 1000 volts) is applied to the piston pin 10. The process produces a mixed layer at the surface leading to enhanced adhesion of the coating 16. Coating is undertaken by switching on all evaporation sources, reducing the voltage to around 200 volts and admitting the necessary gases to produce the compound required. Because the piston pin 10 is hot at the end of the coating cycle, it is necessary to allow the piston pin 10 to cool to below about 200C before removing the piston pin 10 from the chamber to avoid discoloring any uncoated areas.

In the preferred embodiment, the chromium nitride coating 16 is applied to the piston pin 10 to a thickness of between 1 and 10 microns and is preferably about 5 microns.

After the coating 16 is applied to the piston pin 10, the piston pin 10 is preferably subjected to a centerless buffing operation. In a centerless buffing operation, the piston pin 10 is supported between counter rotating buffing wheels, as depicted in FIG. 7. Such buffing imparts a near mirror finish to the outside margin of the coating 16.

While a number of presently preferred embodiments of the invention have been described, it should be appreciated the inventive principles can be applied to other embodiments falling within the scope of the following claims.

1. A piston pin, comprising:
a tubular body having a cylindrical exterior margin, the exterior margin being shiftably matable with an inside margin of a pin bore of a connecting rod, the margin of the pin bore having a surface formed of the material forming the connecting rod, the mating being in a surface to surface engagement.

2. The piston pin of claim 1 having a chromium-nitride coating disposed on the tubular body, the coating comprising the piston pin cylindrical exterior margin.

3. The piston pin of claim 2, the chromium-nitride coating being deposited by physical vapor deposition.

4. The piston pin of claim 2, the chromium-nitride coating being deposited to a depth of between 1 and 10 microns.

5. The piston pin of claim 4, the chromium-nitride coating being deposited to a depth of substantially 5 microns.

6. The piston pin of claim 2, the chromium-nitride coating being buffed after deposition.

7. The piston pin of claim 6, the chromium-nitride coating being buffed in a centerless buffing operation.

8. A piston pin, connecting rod combination comprising:
the piston pin having a tubular body, the tubular body having a cylindrical exterior margin, the exterior margin being shiftably matable with an inside margin of a pin bore of the connecting rod; and
the connecting rod being formed of a certain material, the inside margin of the pin bore having a surface formed of the certain material forming the connecting rod, the mating with the piston pin being a surface to surface engagement.

9. The piston pin, connecting rod combination of claim 8, the piston pin having a chromium-nitride coating disposed on the tubular body, the coating comprising the pin cylindrical exterior margin.

10. The piston pin, connecting rod combination of claim 9, the chromium-nitride coating being deposited by physical vapor deposition.

11. The piston pin, connecting rod combination of claim 9, the chromium-nitride coating being deposited to a depth of between 1 and 10 microns.

12. The piston pin, connecting rod combination of claim 11, the chromium-nitride coating being deposited to a depth of substantially 5 microns.

13. The piston pin, connecting rod combination of claim 2, the chromium-nitride coating being buffed after deposition.

14. The piston pin, connecting rod combination of claim 13, the chromium-nitride coating being buffed in a centerless buffing operation.

15. A method of forming a piston pin, comprising:
forming a tubular body having a cylindrical exterior margin, the exterior margin shiftably mating the exterior margin with an inside margin of a pin bore of a connecting rod;
forming the connecting rod of a certain material;
forming the surface margin of the pin bore of the certain material employed in forming the connecting rod;
and mating the exterior margin of piston pin with the inside margin of the pin bore in a surface to surface engagement.

16. The method of claim 15 including disposing a chromium-nitride coating on the tubular body, the coating comprising the pin cylindrical exterior margin.

17. The method of claim 16, including depositing the chromium-nitride coating by physical vapor deposition.

18. The method of claim 16, including depositing the chromium-nitride coating to a depth of between 1 and 10 microns.

19. The method of claim 16, including depositing the chromium-nitride coating to a depth of substantially 5 microns.

20. The method of claim 16, including buffing the chromium-nitride coating after deposition.

21. The method of claim 20, including buffing the chromium-nitride coating in a centerless buffing operation.
